(19) United States
(12) Patent Application Publication
(10) Pub. No.: US 2013/0167501 A1
(43) Pub. Date: Jul. 4, 2013

(54) CAMLESS PICKUP WRAPPER

(71) Applicant: AGCO Corporation, Duluth, GA (US)

(72) Inventor: Jason L. Seeger, Newton, KS (US)

(73) Assignee: AGCO CORPORATION, Duluth, GA (US)

(21) Appl. No.: 13/721,987

(22) Filed: Dec. 20, 2012

Related U.S. Application Data
(60) Provisional application No. 61/580,856, filed on Dec. 28, 2011.

(51) Int. Cl. A01D 89/00

(52) U.S. Cl. CPC A01D 89/002
USPC 56/364

(57) ABSTRACT

In one embodiment, a camless pickup assembly comprising a cam independent, rotatable reel having a plurality of tines affixed thereto and spaced apart from each other by a respective predefined first gap radially on the reel and spaced apart by a respective predefined second gap transversely across the reel; and a plurality of tine wrappers distributed transversely along the reel and occupying each of the respective second gaps, wherein a first of the plurality of tines is configured to extend past a plane of the tine wrapper surface according to a substantially constant length throughout a first arc of rotation and a second of the plurality of tines is configured to extend past the plane of the tine wrapper surface according to a gradually decreasing length throughout a second arc of rotation, the second of the plurality of tines spaced radially from the first of the plurality of tines by the predefined first gap.

### CROSS REFERENCE TO RELATED APPLICATION

This application claims priority to copending U.S. provisional application entitled, “Camless Pickup Wrapper,” having ser. No. 61/580,856, filed Dec. 28, 2011, which is entirely incorporated herein by reference.

### TECHNICAL FIELD

The present disclosure is generally related to agricultural machinery, and, more particularly, pickup assemblies for agricultural machinery.

### BACKGROUND

Agricultural machinery, such as balers, have a pickup assembly with a row of tines to pick up biomass from the ground and transfer the biomass to bale forming machinery internal to the baler. For instance, conventional baler pickup assemblies have a row of tines on a rotating reel that is disposed across the pickup assembly, the pickup assembly in turn bolted to a structural member that has wrappers fitted between each of the tines to guide crop over the pickup assembly and into the baler.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an example environment in which an embodiment of a camless pickup assembly may be used.

FIG. 2 is an overhead perspective view of an embodiment of a camless pickup assembly.

FIG. 3 is a partial front perspective view of an embodiment of a portion of a camless pickup assembly.

FIGS. 4A-4D are schematic diagrams in side elevation view of a cut-away of a reel assembly and wrapper of an embodiment of a camless pickup assembly in various stages of reel rotation.

FIG. 5 is an exploded view of certain components of an embodiment of a camless pickup assembly.

FIG. 6 is a flow diagram of an embodiment of an example camless pickup method.

### DESCRIPTION OF EXAMPLE EMBODIMENTS

### Overview

In one embodiment, a camless pickup assembly comprising a cam independent, rotatable reel having a plurality of tines affixed thereto and spaced apart from each other by a respective predefined first gap radially on the reel and spaced apart by a respective predefined second gap transversely across the reel; and a plurality of tine wrappers distributed transversely along the reel and occupying each of the respective second gaps, wherein a first of the plurality of tines is configured to extend past a plane of the tine wrapper surface according to a substantially constant length throughout a first arc of rotation and a second of the plurality of tines is configured to extend past the plane of the tine wrapper surface according to a gradually decreasing length throughout a second arc of rotation, the second of the plurality of tines spaced radially from the first of the plurality of tines by the predefined first gap.

### DETAILED DESCRIPTION

Certain embodiments of an invention comprising a camless pickup assembly and associated method are disclosed that enable an agricultural machine (e.g., baler or other crop material gathering machinery) to efficiently gather crop material, such as biomass, while providing dependable service. In one embodiment, the camless pickup assembly comprises a respective tine wrapper that occupies each space between the tines in a transverse row of tines, the tine wrapper comprising multiple radii that enable crop material gathered by the tines in a row to be gradually stripped (e.g., throughout a greater arc of rotation of the reel) by each of the wrappers disposed between the tines. For instance, as a row of tines rotate from the bottom in clockwise rotation, the amount (e.g., length) of tine extending past a plane of the surface (e.g., outward surface) of the tine wrapper gradually decreases (due to the increasing radius of each of the wrappers). Further, as suggested by the term camless, the reel of the camless pickup assembly is driven without a cam coupled to the shaft of the reel (i.e., it is a cam-independent, rotatable reel). Hence, the angle between each tine and the reel is substantially fixed in the undeflected state throughout the entire rotation of the reel (though allowing some minor deflection and hence minor deviation from a fixed angle when the tine encounters objects to absorb impact), providing reliable, cost effective service.

In contrast, conventional, camless pickup assemblies may comprise wrappers that have a single radius resulting in stripping action occurring in a condensed region, which may cause the crop material to accumulate toward the top of the rotation, raising the risk of forcing crop material through the wrappers and causing internal interference with the internal workings of the reel assembly. In addition, some conventional implementations utilize a cam pickup assembly (e.g., where the tines collapse for a predefined arc of reel rotation in an undeflected state, resulting in a deliberate and substantial deviation in the angle between each tine and the reel for that portion of the rotation), which requires the need for cam tracks and added bearings associated with driving the shaft of the reel, which adds cost and/or may decrease the amount of service-free days of the pickup assembly.

Having summarized various features of certain embodiments of a camless pickup assembly of the present disclosure as compared to conventional assemblies, reference will now be made in detail to the description of the disclosure as illustrated in the drawings. While the disclosure is described in connection with these drawings, there is no intent to limit it to the embodiment or embodiments disclosed herein. For instance, though an agricultural machine embodied as a square baler towed by another vehicle (e.g., combine harvester, tractor, etc.) is described herein as one example environment in which certain embodiments of camless pickup assemblies are implemented, it should be appreciated that other agricultural machines may utilize certain embodiments of a camless pickup assembly (or their sub-assemblies), such as round balers, self-propelled balers, and machines equipped to gather crop material such as biomass or other types of crop material, including crop material as harvested by non-baling machines, such as forage harvesters. Further, although the description identifies or describes specifics of one or more embodiments, such specifics are not necessarily part of every embodiment, nor are all various stated advantages associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

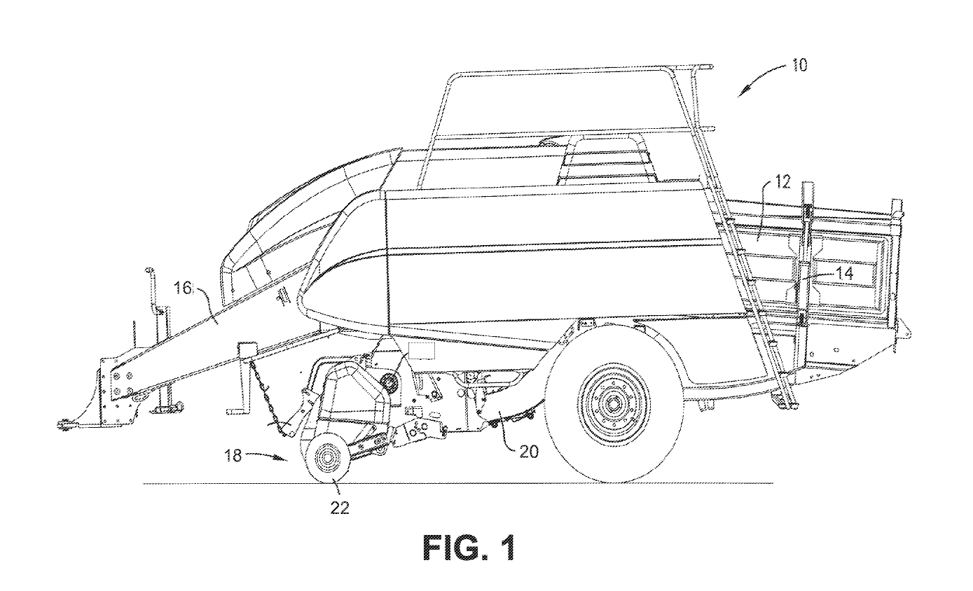

Referring now to FIG. 1, shown is an example environment 10 in which certain embodiments of a camless pickup assembly may be employed. One having ordinary skill in the art should appreciate in the context of the present disclosure that the example environment 10 is merely illustrative, and that camless pickup assemblies as disclosed herein may be implemented in other environments. The example environment, depicted in FIG. 1 as a towed square baler 10, has a fore-and-aft extending baling chamber denoted generally by the numeral 12 within which bales of crop material are prepared. In the particular illustrated embodiment, baler 10 is an “extrusion” type baler in which the bale discharge orifice at the rear of the baler is generally smaller than upstream portions of the chamber such that the orifice restricts the freedom of movement of a previous bale and provides back pressure against which a reciprocating plunger (not shown) within the baling chamber 12 can act to compress charges of crop materials into the next bale. The dimensions of the discharge orifice and the squeeze pressure on the bales at the orifice are controlled by a compression mechanism broadly denoted by the reference numeral 14 in FIG. 1. The baler 10 is hitched to a towing vehicle (not shown) by a fore-and-aft tongue 16, and power for operating the various mechanisms of the baler is supplied by the towing vehicle, though not limited as such.

The baler 10 is an “in-line” type of baler wherein crop material (e.g., biomass) is picked up below and slightly ahead of the baling chamber 12 and then loaded up into the bottom of the chamber 12 in a straight line path of travel. A camless pickup assembly broadly denoted by the numeral 18 is positioned under the tongue 16 on the longitudinal axis of the machine, somewhat forwardly of the baling chamber 12. A charge forming duct 20 extends generally rearwardly and upwardly from a point just behind the camless pickup assembly 18 to an opening in the bottom of the baling chamber 12. A plunger reciprocates within the baling chamber 12 in compression and retraction strokes across the opening at the bottom of the baling camber 12. When fully retracted, the plunger uncovers the opening, and when fully extended, the plunger completely covers and closes off the opening.

The duct 20 defines an internal passage through which crop material travels from the camless pickup assembly 18 to the baling chamber 12 during operation of the baler 10. The front end of the duct 20 is open to present an inlet into the internal passage, and an outlet of the duct is defined by the opening into the baling chamber 12. A top wall of the duct 20 is defined by a series of laterally spaced apart straps that extend downwardly and forwardly from the baling chamber 12 and terminate in forwardmost upturned front ends generally above the inlet to the duct 20. The rear of the camless pickup assembly 18 has a centrally disposed discharge opening defined in part by a transition pan, in fore-and-aft alignment with the inlet to the duct 20, as is known.

The camless pickup assembly 18 has a pair of ground wheels 22 (one shown) that support the camless pickup assembly 18 as the baler 10 advances along the ground. The camless pickup assembly 18 is mounted to the front chassis of the baler 10 for pivoting movement about an upwardly and rearwardly disposed transverse pivot axis. Flotation for the camless pickup assembly 18 may be provided by a number of different flotation mechanisms well-known in the art.

A relatively short, transversely channel-shaped chute (e.g., transition pan) projects rearwardly from the camless pickup assembly 18 and is slidably received within the front end of the duct 20. The chute serves as a transition piece between the camless pickup assembly 18 and the duct 20 for crop flow as the camless pickup assembly 18 rises and falls over uneven terrain relative to the duct 20 during operation.

The baler 10 may further comprise a feeding mechanism for moving crop materials through the duct 20. Such feeding mechanism may, for example, comprise a suitable rotor (e.g., rotating mechanism) associated with a cutter mechanism, or it may comprise other apparatus. For instance, the feeding mechanism may include a packer and a stuffer as is conventional and well understood by those skilled in the art. The packer is used to receive materials from the camless pickup assembly 18 and pack the same into the duct 20 for preparing a precompressed, preshaped charge of crop materials that conforms generally to the interior dimensions of the duct 20. The stuffer, as is conventional and well understood by those skilled in the art, functions to sweep (e.g., through its own kidney shaped path of travel) the prepared charge up into baling chamber 12 between compression strokes of the plunger when the opening at the floor of the baling chamber 12 is uncovered.

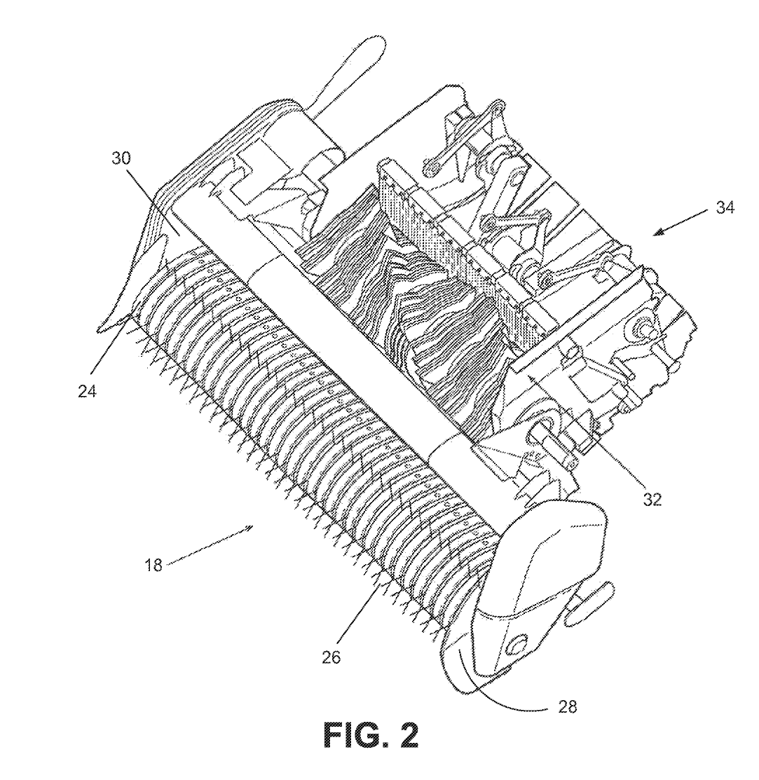

Having generally described an example baler 10 upon which a camless pickup assembly 18 is mounted, attention is directed to the example camless pickup assembly 18 as shown in FIG. 2. One having ordinary skill in the art should appreciate in the context of the present disclosure that the camless pickup assembly 18 depicted in FIG. 2 is merely illustrative, and that other variations with the same or different features may be employed in some embodiments. In the depicted embodiment, the camless pickup assembly 18 comprises a plurality of tine wrappers 24, each wrapper occupying a gap between adjacent tines 26. The tines are affixed to a reel that is obscured from view by the plural wrappers 24. The reel (and hence wrappers 24 and tines 26) is coupled between two opposing end members 28 and 30), and rotates in a clockwise manner (e.g., from the perspective of the left profile) picking up crop material from the ground (or routed from a pan) and drawn toward a rear center portion by stub augers (not shown). The baler 10 further comprises a cutter 32 positioned after the camless pickup assembly 18 and before a packer 34 to, for instance, reduce the distance the crop material must travel from a combine (or other towing machine) towing the baler 10 before it is baled.

In some embodiments, the baler 10 may include a rotary feeding mechanism rather than the cutter 32. A rotary feeder is distinguishable from the cutter 32 in that the blades are different and that on some occasions it is not desirable to cut the crop material any further than it already has been. On such occasions, it may be desirable to merely feed the crop material with the rotary feeder into the packer 34. In some embodiments, crop material may be fed directly from the pickup assembly 18 to the packer 34.

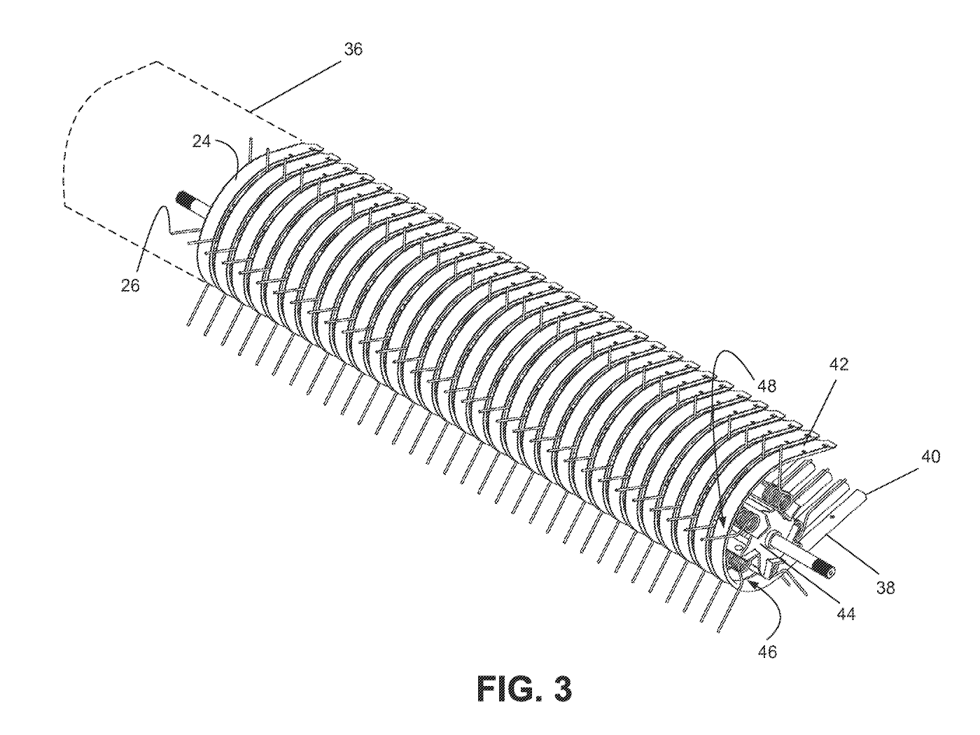

FIG. 3 is a perspective, front elevation view of the tines 26 and their position relative to the tine wrappers 24. When the outer surface of the tine wrappers 24 is extended in each direction (one direction shown in FIG. 3), it is apparent that the extended surface comprises a plane 36 circumferentially outlining the radial surfaces of the tine wrappers 24. This plane 36 is “broken” by each of the tines 26 during at least a majority portion of the reel rotation. In other words, each tine 26 of any given row of tines, as it rotates in a clockwise direction (e.g., viewed from the left profile), extends beyond the plane 36. This extension beyond the plane of the tine wrappers 24 varies since each tine wrapper 24 is defined by multiple radii. It is noted that each tine wrapper 24 comprises a flat portion 38 proximal to one end 40 of the tine wrapper 24. At the other end 42 of the tine wrapper 24 is another flat portion, as best illustrated in later described figures.

Each tine 26 is affixed to a rotatable, cam-independent reel 44. In the embodiment depicted in FIG. 3, the tines 26 are affixed along a respective row, each row located at fixed, angular positions along the circumference of the reel 44. In other words, looking at a single tine for each row along a radial axis, each tine 26 is located (aligned) along a radial axis of the circumference of the reel, separated from adjacent tines 26 along that radial axis by a respective gap. In some embodiments, there may be more or fewer tines 26 located along each radial axis, and hence separated from adjacent tines 26 along that radial axis by smaller-sized or larger-sized gaps, respectively. Stated differently, it should be appreciated that, though five (5) rows of tines are depicted in the example embodiment of FIG. 3, some embodiments may use additional rows (e.g., six (6) rows, etc.) or fewer (e.g., four (4) rows, three (3) rows, etc.).

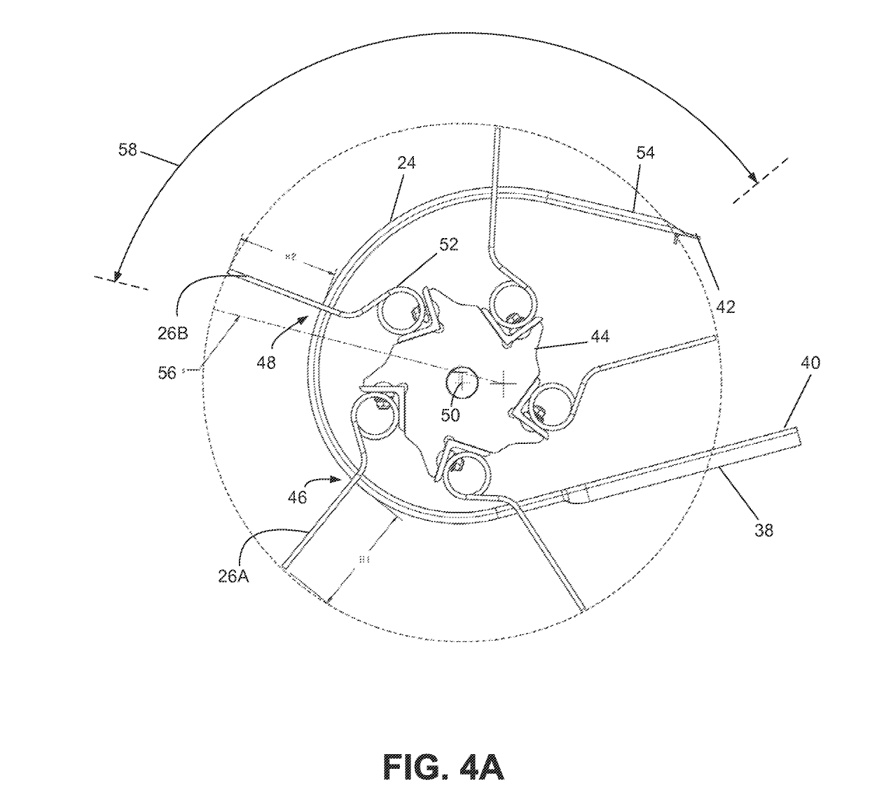

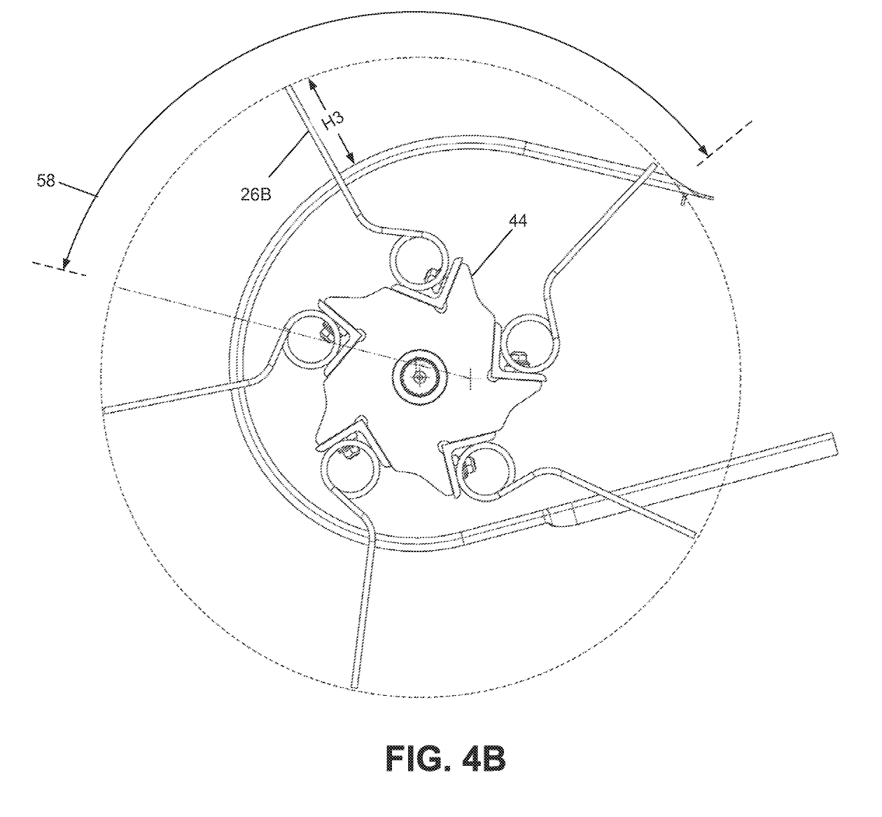

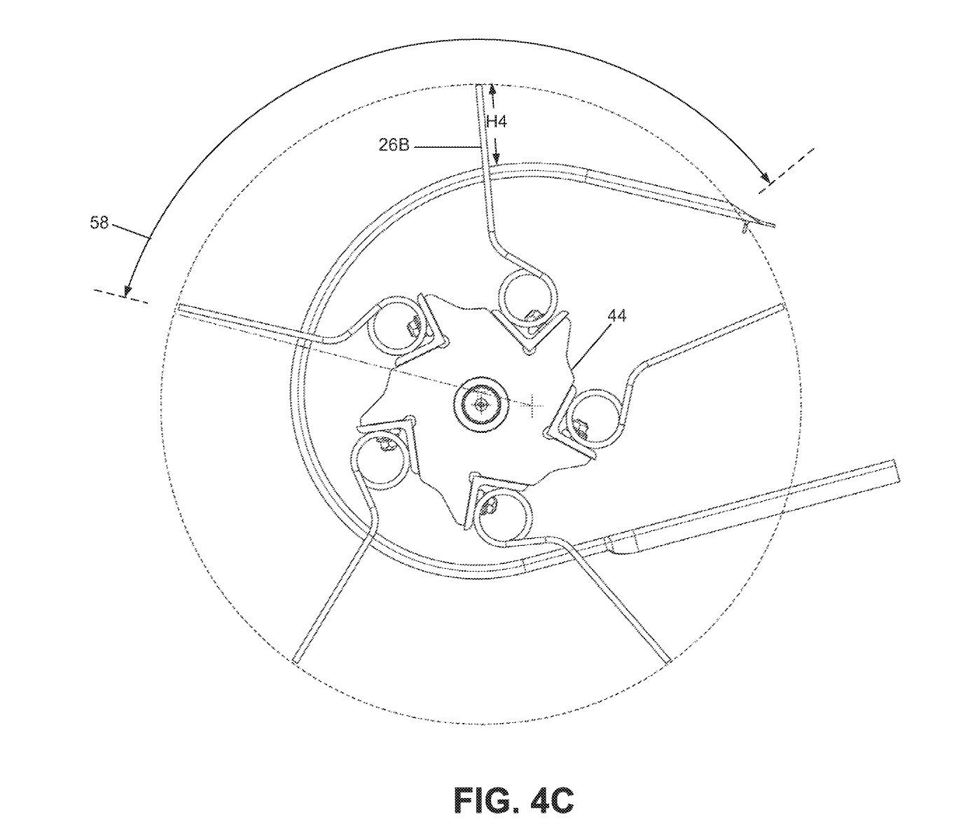

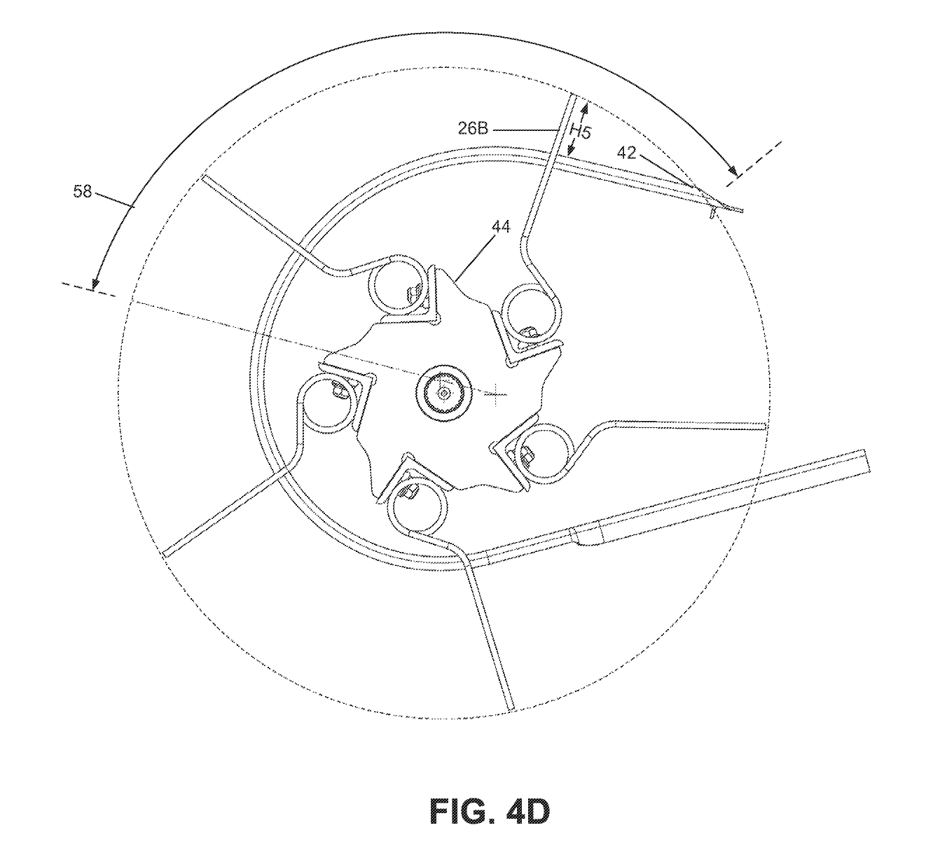

As explained further below in association with FIGS. 4A-4D, each tine wrapper 24 comprises multiple radii. For instance, a first radius may extend from the center of the reel 44 to a location 46 on the tine wrapper 24, and a second radius may extend from a location offset from the center of the reel 44 to a location 48 on the tine wrapper 24. In some embodiments, the tine wrapper 24 may define an additional radius or radii. As the reel 44 rotates in the clockwise direction (viewed from the left profile), at a given snapshot or instance in time (such as shown in FIG. 3), the tines 26 extend past the plane 36 adjacent location 46 a first distance, and past the plane 36 adjacent location 48 by a second distance. For instance, in one embodiment, the distance or length the tines 26 extend past the plane 36 from, say, a rotation from location 46 to approximately location 48 (one example arc of rotation) may be constant or, generally, substantially constant (e.g., from constant up to approximately 10% change in exposed tine), whereas the length of extension for a rotation for the tines 26 past the plane 36 from approximately location 48 to the location near the end 42 where the tines 26 no longer extend past the plane 26 (another example arc of rotation) reveals a gradual decrease. In other words, the rate of change (e.g., decrease) of length extending from the plane 36 is greater in the latter arc of rotation than the former. The gradual disappearance (e.g., in one embodiment, in a range of up to approximately 90°-200°, or in some embodiments, in a range of approximately 110°-120°) of the row of tines 26 from extension beyond the plane 36 through rotation of the reel 44 may result in a more efficient, gradual stripping of crop material from the tines 26 relative to the tine wrappers 24 located adjacent each side of a given tine 26.

Referring to FIG. 4A, shown is a schematic diagram of the reel 44, tines 26 (e.g., 26A and 26B, etc.), and tine wrapper 24 in end elevation view. The tine wrapper 24 is depicted with the flat portion 38 at the one end (lower) 40 and a flat portion 54 at the other (upper) end 42. The reel 44 may comprise a solid metal bulkhead with a center shaft 50 coincident with a center reference (depicted with the centered “+” in FIG. 4A) associated with one of the multiple radii. Additional radii associated with other points of reference are also depicted with “+,” such as one reference (“+”) shown offset toward the upper edge of the shaft outline and another reference for an associated radius shown offset to the right of the shaft 50. It should be appreciated that fewer or additional radii (and hence fewer or additional references) are contemplated to be within the scope of the disclosure. In some embodiments, the multiple radii may refer to non-discrete radii, such as continuous radii (e.g., a spiral). The shaft 50 is driven by an on-board motor alone or in combination with a power take-off (PTO) associated with the towed and/or towing vehicle, as is known. The shaft 50 drives the reel 44 rotation in a cam-independent manner, and (as depicted in the view of FIG. 4A) in clockwise rotation, spinning the tines 26 around in kind.

The circular path of the tips of the tines 26 as the reel 44 rotates is shown in FIG. 4A (and FIGS. 4B-4D) using a dashed line, and tangent points of two example wrapper arcs (one shown associated with a dashed line 56 running from one of the offset references to the outline of the tine tip path at approximately midway between, using a clock analogy, the 9:00 and 10:00 o'clock positions) are used for referencing two radial locations 46 and 48 of the tine wrapper 24 where the radii for the respective tines 26A and 26B differ. For instance, the tangent point associated with the dashed line 56 reveals a transition from one radius associated with the centered reference (e.g., concentric or approximately concentric with the shaft center 50) to another radius associated with the offset reference located to the right of the shaft 50 in FIG. 4A. As noted above, the tine 26A adjacent position 46 of the tine wrapper 24 extends a first distance, H1, from the plane 36 (FIG. 3) of the tine wrapper surface. Adjacent the position 48 of the tine wrapper 24, the tine 26B extends a second distance, H2, from the plane 36 of the tine wrapper surface. In one embodiment, H2 is less than H1. In one embodiment, the distance the tine 26A extends from the plane 36 of the tine wrapper 24 is substantially constant between the location 46 and just prior to the location 48, and the distance the tine 26B extends from the plane 36 of the tine wrapper 24 gradually decreases as the tine 26B progresses from the location 48 of the tine wrapper 24 to the end 42 corresponding to arc of rotation 58 (e.g., the arc defined at least in part by a tip of the tine as the reel 44 rotates). As indicated above, the arc of rotation 58 corresponds to a gradual decline in height of the tine exposed past the plane of the surface of the tine wrapper 24, and in some embodiments, the arc may be approximately 110° as depicted in FIG. 4A, though other arc dimensions or ranges are contemplated to be within the scope of the disclosure, as described above.

The tines 26 (e.g., 26A and 26B) are depicted in this illustrative example as straight edged tines 26 coupled (e.g., affixed, such as bolted) to the bulkhead of the reel 44 and including a coil spring 52. The coupling may be according to an intermediate, metal (or other material in some embodiments) member (not shown) or direct coupling, each collectively referred to as being affixed to the reel 44. In some embodiments, other tine configurations may be used, such as curved tines, comprised of metal or non-metal material, with or without a coil. In some embodiments, the tines 26 may be mounted in rubber (e.g., non-coiled). Further, it is noted that the tines 26 always have a fixed angle, relative to the reel 44, in undeflected state, as should be appreciated by one having ordinary skill in the art in the context of camless-type pickup assemblies. Stated differently, in the example depicted in FIG. 4A, the angle between any given tine and the reel always remains the same in an undeflected state (e.g. there may be some deflection of the tines, and hence alteration of the angle, when engaged with crop material or other objects) throughout a complete rotation of the reel 44. In some embodiments, the tines 26 may be fixed or rigid, and hence of the same or similar configuration whether in deflected or undeflected states.

FIGS. 4B-4D illustrate an example of the gradual reduction of exposed tine 26B to the crop material as the reel 44 rotates throughout the arc of rotation 58. It should be appreciated that the examples depicted in FIGS. 4A-4D are non-limiting, and that in some embodiments, the gradual reduction in exposure of the tine 26B may begin at location 48, location 46, or other locations (e.g., at approximately the 6:00 o'clock location of the reel 44) with the same or a different rate of change than previously disclosed depending on the geometry of the tine wrapper 24 and the quantity of radii. As shown in FIG. 4B, the tine 26B has advanced in the clockwise direction along the arc of rotation 58 relative to its location in FIG. 4A, resulting in a length H3 of exposed tine, where H3 is less than H2. In the example depicted in FIG. 4C, the tine 26B has advanced in the clockwise direction along the arc of rotation 58 relative to its location in FIG. 4B, resulting in a length H4 of exposed tine, where H4 is less than H3. Referring to the example depicted in FIG. 4D, the tine 26B has advanced in the clockwise direction along the arc of rotation 58 relative to its location in FIG. 4C, resulting in a length H5 of exposed tine, where H5 is less than H4. As evident from these examples, as the reel 44 rotates the tine 26B past the end 42, the flat portion 54 (e.g., FIG. 4A) toward the end 42 of the wrapper 24 achieves a final stripping action to enable the crop material to be transitioned to the subsequent section for further processing. However, it should be appreciated from these examples that there is a gradual stripping action achieved through the use of multiple radii (e.g., two radii, though three or more may be used in some embodiments), and not an abrupt and condensed (e.g., in a small area) action as is conventional in the art.

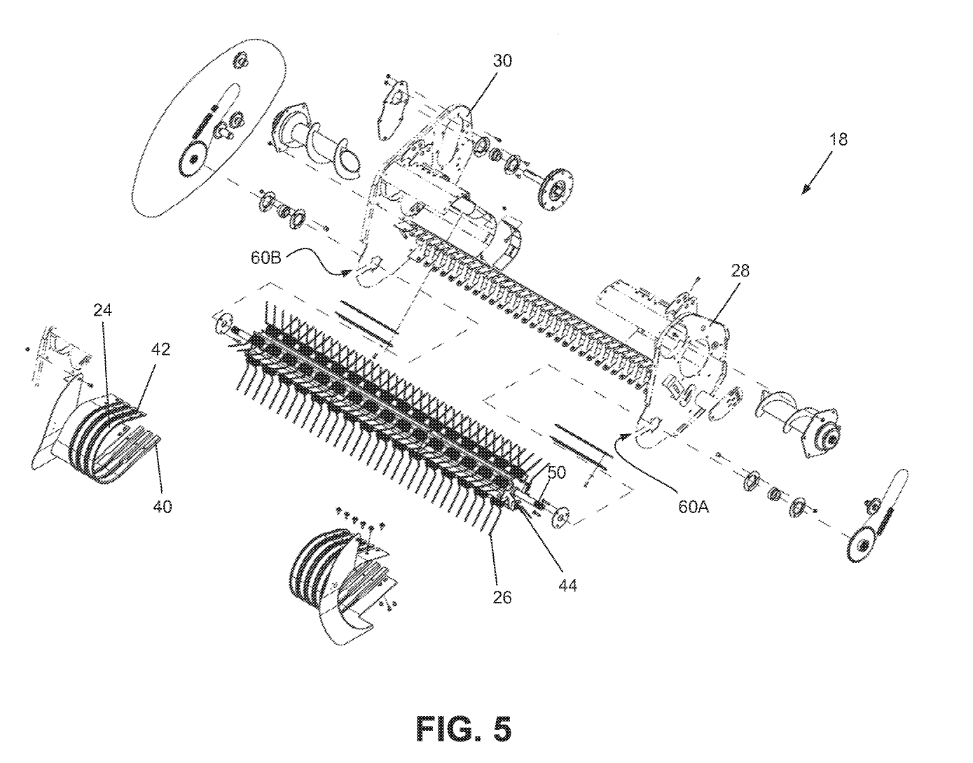

FIG. 5 provides an exploded view of certain features of the camless pickup assembly 18. Certain referenced features of the camless pickup assembly 18 have already been described, and hence omitted from explanation here except where desired for context. It is noted that the tines 26 are configured as straight-edged tines, though curved tines are likewise contemplated as explained above. Introduced in FIG. 5 are loading slots 60A and 60B of end members 28 and 30, respectively, in which the shaft 50 of the reel 44 inserts in and is secured via bearings. Notably absent is a cam and associated bearings. It should be appreciated that the embodiment depicted in FIG. 5 is merely illustrative, and that other configurations are contemplated to be within the scope of the disclosure.

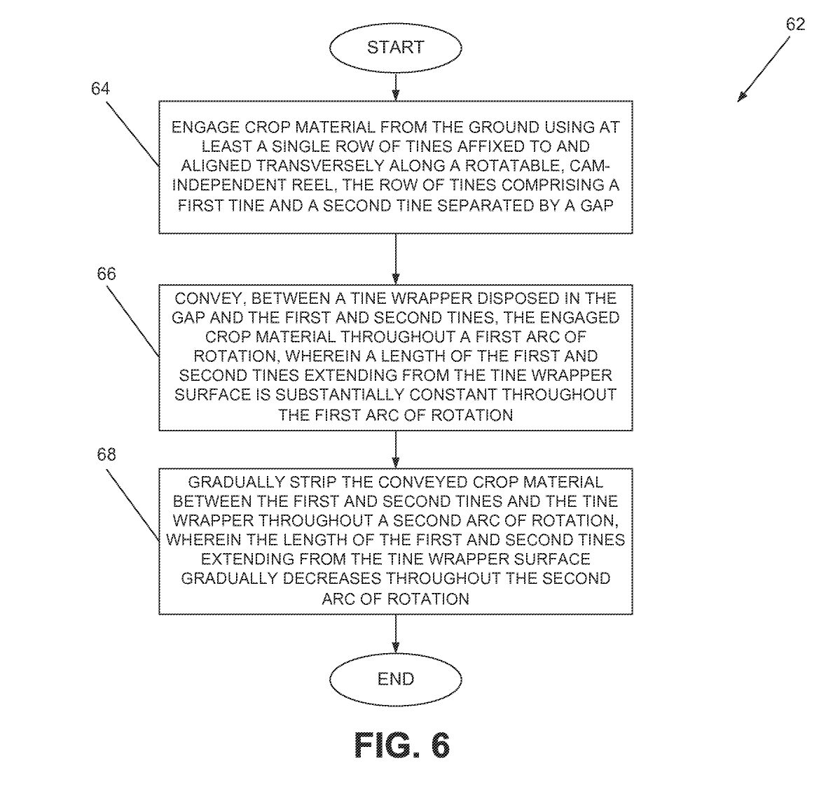

In view of the above disclosure, it should be appreciated that one embodiment of a camless pickup method implemented by the camless pickup assembly 18, or variations thereof in some embodiments, and denoted method 62 in FIG. 6, comprises engaging crop material from the ground using at least a single row of tines affixed to and aligned transversely along a rotatable, cam-independent reel, the row of tines comprising a first tine and a second tine separated by a gap (64). The method 62 further comprises conveying, between a tine wrapper disposed in the gap and the first and second tines, the engaged crop material throughout a first arc of rotation, wherein a length of the first and second tines extending from the tine wrapper surface is substantially constant throughout the first arc of rotation (66). As described previously, substantially constant may be constant in some embodiments, and in some embodiments, substantially constant may be some change (e.g., up to approximately 10% change in exposed length). The method 62 further comprises gradually stripping the conveyed crop material between the first and second tines and the tine wrapper throughout a second arc of rotation, wherein the length of the first and second tines extending from the tine wrapper surface gradually decreases throughout the second arc of rotation (68).

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A camless pickup assembly comprising:
a cam independent, rotatable reel having a plurality of tines affixed thereto and spaced apart from each other by a respective predefined first gap radially on the reel and spaced apart by a respective predefined second gap transversely across the reel; and
a plurality of tine wrappers distributed transversely along the reel and occupying each of the respective second gaps, wherein a first of the plurality of tines is configured to extend past a plane of the tine wrapper surface according to a substantially constant length throughout a first arc of rotation and a second of the plurality of tines is configured to extend past the plane of the tine wrapper surface according to a gradually decreasing length throughout a second arc of rotation, the second of the plurality of tines spaced radially from the first of the plurality of tines by the predefined first gap.

2. The camless pickup assembly of claim 1, wherein each tine wrapper further comprises a substantially flat portion at each end of the wrapper.

3. The camless pickup assembly of claim 1, wherein each tine comprises a coiled spring coupled to the reel.

4. The camless pickup assembly of claim 1, wherein the second arc of rotation is adjacent the first arc of rotation.

5. The camless pickup assembly of claim 1, wherein the gradually decreasing length throughout the second arc of rotation occurs at a greater rate than a decreasing length associated with the first arc of rotation.

6. The camless pickup assembly of claim 1, wherein the second arc of rotation is greater than ninety degrees.

7. The camless pickup assembly of claim 1, wherein the plurality of tines are curved.

8. The camless pickup assembly of claim 1, wherein the plurality of tines are rubber mounted.

9. A camless pickup method comprising:
engaging crop material from the ground using at least a single row of tines affixed to and aligned transversely along a rotatable, cam-independent reel, the row of tines comprising a first tine and a second tine separated by a gap;
conveying, between a tine wrapper disposed in the gap and the first and second tines, the engaged crop material throughout a first arc of rotation, wherein a length of the first and second tines extending from the tine wrapper surface is substantially constant throughout the first arc of rotation; and
gradually stripping the conveyed crop material between the first and second tines and the tine wrapper throughout a second arc of rotation, wherein the length of the first and second tines extending from the tine wrapper surface gradually decreases throughout the second arc of rotation.

10. The camless pickup method of 9, further comprising engaging additional crop material from the ground with additional rows of tines affixed to and aligned transversely along the rotatable, cam-independent reel.

11. The camless pickup method of claim 9, further comprising engaging the crop material from the ground with additional tines from the row of tines affixed to and aligned transversely along the rotatable, cam-independent reel.

12. The camless pickup method of claim 9, wherein the second arc of rotation is adjacent the first arc of rotation.

13. The camless pickup method of claim 9, wherein the second arc of rotation is greater than ninety degrees.

14. The camless pickup method of claim 9, wherein the gradually decreasing length throughout the second arc of rotation occurs at a greater rate than a decreasing length associated with the first arc of rotation.

15. The camless pickup method of claim 9, wherein the second arc of rotation terminates when the first and second tines disappear from the surface of a substantially flat portion of the tine wrapper.

16. The camless pickup method of claim 9, wherein the first and second tines are curved.

17. An agricultural machine, comprising:
a camless pickup assembly, the pickup assembly comprising:
a rotatable reel having plural rows of tines affixed thereto and spaced radially apart from each other by a respective predefined first gap, each tine in a row spaced transversely apart by a respective predefined second gap; and
a plurality of tine wrappers distributed transversely along the reel and occupying each of the respective second gaps, wherein for a given instance of reel rotation, a first of the plural rows of tines is configured to have a first length of extension beyond a surface of the plurality of tine wrappers and a second of the plural rows is configured to have a second length of extension beyond the surface of the plurality of tine wrappers, the second adjacent the first.

18. The agricultural machine of claim 17, wherein the first of the plural tines is closer to the ground than the second of the plural tines, wherein the second length is shorter than the first length.

19. The agricultural machine of claim 17, further comprising a third of the plural rows of tines adjacent the second of the plural rows of tines, the third of plural rows of tines at the instance of reel rotation having a third length of extension beyond the surface of the plurality of tine wrappers that is less than the second length.

20. The agricultural machine of claim 17, further comprising a fourth of the plural rows of tines adjacent the first of the plural rows of tines, the fourth of plural rows of tines at the instance of reel rotation having a length of extension substantially equal to the first length.
